(19) United States
(12) Patent Application Publication
(10) Pub. No.: US 2005/0283380 A1
(43) Pub. Date: Dec. 22, 2005

(54) Delivery service for a health management system

(76) Inventor: Ramon Sanchez Garduno, Sevilla (ES)

Correspondence Address: JACOBSON HOLMAN PLLC, 400 SEVENTH STREET N.W., SUITE 600, WASHINGTON, DC, 20004, US

(21) Appl. No.: 10/869,888

(22) Filed: Jun. 18, 2004

(51) Int. Cl. G06Q 50/00

(52) U.S. Cl. 705/2; 705/3; 600/573

(57) ABSTRACT

A health delivery service includes a base terminal for self-testing with a remote on-line connection to a Medical Management Center (MMC). A customer provides biological fluids to the base terminal for analysis. The base terminal sends test data to the MMC. The MMC processes and evaluates the results in real time and keeps a personal medical data file for each customer. The MMC communicates with the customer, providing medical assessments and advice on health management. The health delivery system allows customers to manage their own health at home or in another environment without disturbing their daily activity.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to a health delivery service for a health management system for managing health status and the early detection of diseases through a base terminal for self-testing with a remote online connection to a Medical Management Center (MMC).

### BACKGROUND OF THE INVENTION

The new diagnostic and analytical technologies and the advances in the field of physiopathology allow the detection of a number of specific disease-generated substances. Many of these are not just specific to a particular pathology, but are likely to be detected in the early stages of a disease.

As a consequence, the early detection of these substances, generically known as markers, will allow for early medical action with a simpler therapeutic approach and a higher success rate that will improve the quality of life for individuals. Otherwise, the disease would be dealt in a more advanced development, which means a notably less optimistic prognosis.

Current technology includes sensors and reagents sensitive to blood samples, which enable decisions to be made in environments other than hospitals or laboratories with the latest equipment and highly qualified personnel. For example, U.S. application No. 2002/0115921 (Berlin) discloses a skin patch, wipe, or electronic vapor detector for collecting markers for remote primary or secondary analysis via the generation of a signal, followed by a laboratory analysis of the collected substance.

U.S. Pat. No. 6,429,026 to Pettersson et al. discloses a one-step all-in-one dry reagent immunoassay for measuring biological markers, in which all the assay-specific components are added to a reaction well and dried before the sample is added. The assay-specific components are first immobilized on a solid phase in a reaction well, after which the labeled assay-specific components are added. After this, the reagents are dried and are ready for the addition of the biological sample. The marker(s) to be measured in the sample react with the assay-specific components in the reaction well, and the specific signal generated by the reaction is measured.

U.S. application No. 2002/0169366 (Schmidt et al.), U.S. Pat. No. 5,507,288 (Bocker et al.), U.S. application No. 2002/0045804 (Christopherson et al.), U.S. application No. 2003/0004403 (Drinan et al.), and “DITIS, Collaborative Virtual Medical team for home healthcare of cancer patients” (Pitsillides et al.) disclose the use of some kind of home diagnostic test with remote data communication. In all of these patents, the test is implemented at home but the data obtained is transmitted to a remote recipient.

Most prior art systems are directed to monitoring patients with a pre-existing condition. For example, “Wireless Telemedicine Systems: An Overview” (Pattichis et al.) discloses a number of applications of wireless telemedicine systems, including home health monitoring of cancer patients. An application relating to home health monitoring of cancer patients is detailed in “DITIS, Collaborative Virtual Medical team for home healthcare of cancer patients” (Pitsillides et al.). The DITIS system employs Mobile Agents, Web Databases with Java Database Connectivity, and web based database for storage and processing of information, including Electronic Medical Record (EMR) pertinent to cancer patients, in accordance with National and International standards (e.g. WHO ICD-10, ICD0O, HL7), software for collaborative work, intelligent interface for uniform access to the common database and Group Collaboration software from both fixed and mobile computing units. A home healthcare professional records patient test data into a PDA, which communicates with a central office web server. The system records the new data, identifies its implications, and triggers and transmits messages to members of the patient's medical team.

A few systems are directed to wellness monitoring of a customer, but the parameters monitored are those such as pulse rate, blood pressure, etc. These systems do not monitor biological markers that can detect the presence of any pathological conditions like coagulopathologies, metabolic disorders, heart disease or cancer in an integrated system.

The current technology requires a professional nurse or doctor to make an analysis, and wastes too much time to get the medical assessments.

The home testing devices are developed to control specific chronic diseases, and their very few specifics parameters.

It is to the solution of these and other objects to which the present invention is directed.

### BRIEF SUMMARY OF THE INVENTION

It is therefore a primary object of the present invention to provide a health delivery service for a health management system that permits the management of a customer's health status and also the earliest detection of diseases without disturbing the customer's daily activities. The early detection of diseases will increase the probability of success in a possible therapeutic intervention, will minimize the deterioration of the customer's health and the probability that symptoms will become permanent, so as to improve the quality of life for the customer.

It is another object of the present invention to provide a health delivery service for a health management system in which a portable base terminal can check the level of biological parameters so that a customer can know his or her health status at any time and anywhere.

It is another object of the present invention to provide a health delivery service for a health management system in which a medical management center is provided to keep a personal medical data file for each customer.

It is still another object of the invention to provide a health delivery service in which a base terminal can be used to transmit data from other medical devices by communicating with a medical management center, storing such data together with other data of a customer.

It is another object of the present invention to provide real-time information and advice to a customer about any health problem that may appear.

It is another object of the present invention to provide low cost technology to ordinary people for monitoring the status of their health.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a graph illustrating the advantages of early detection and treatment of a disease, showing the added value of the health delivery system in accordance with the present invention.

FIG. 2 is a diagrammatic representation of a delivery service for a health management system in accordance with the present invention.

FIG. 3 is a diagrammatic representation of the steps carried out by the in the delivery service for a health management system in accordance with the present invention when a customer submits a sample for analysis.

FIG. 4 is a diagrammatic representation of the components of the medical management center of the delivery service of FIG. 2.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

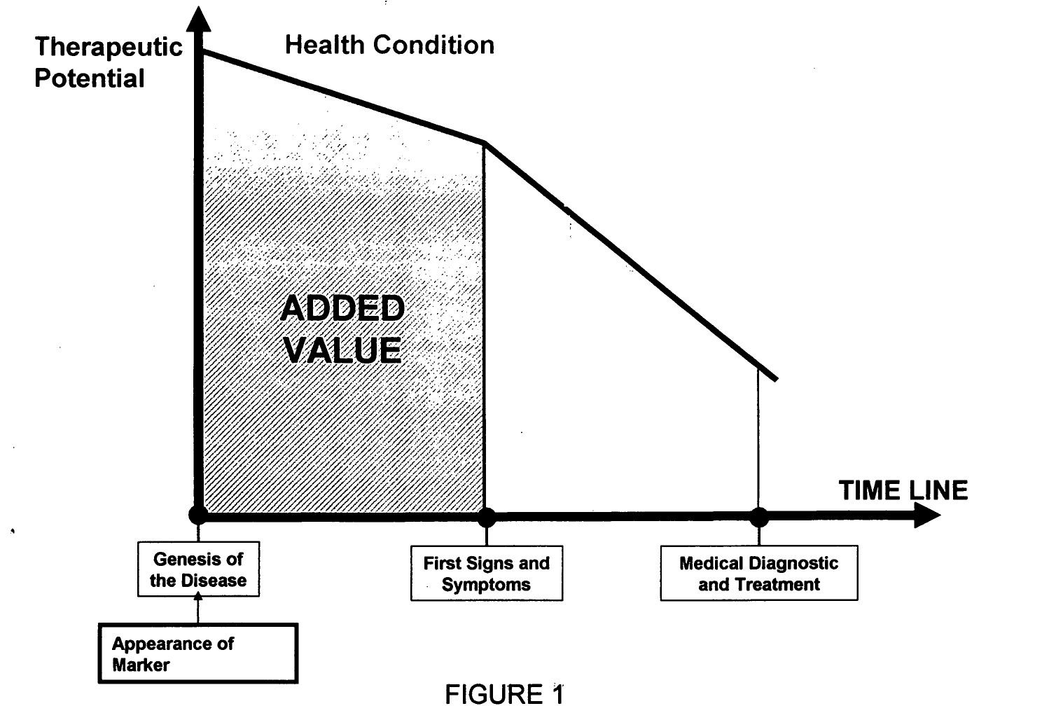

The delivery service for a health management system in accordance with the present invention provides the earliest detection of diseases at home, before the first signs and symptoms appear and conventional medical treatment is undertaken. As shown in FIG. 1, by reducing the time elapsed between the appearance of the disease and medical treatment, a physician will be able to treat the disease before the prognosis and the health of the customer deteriorate.

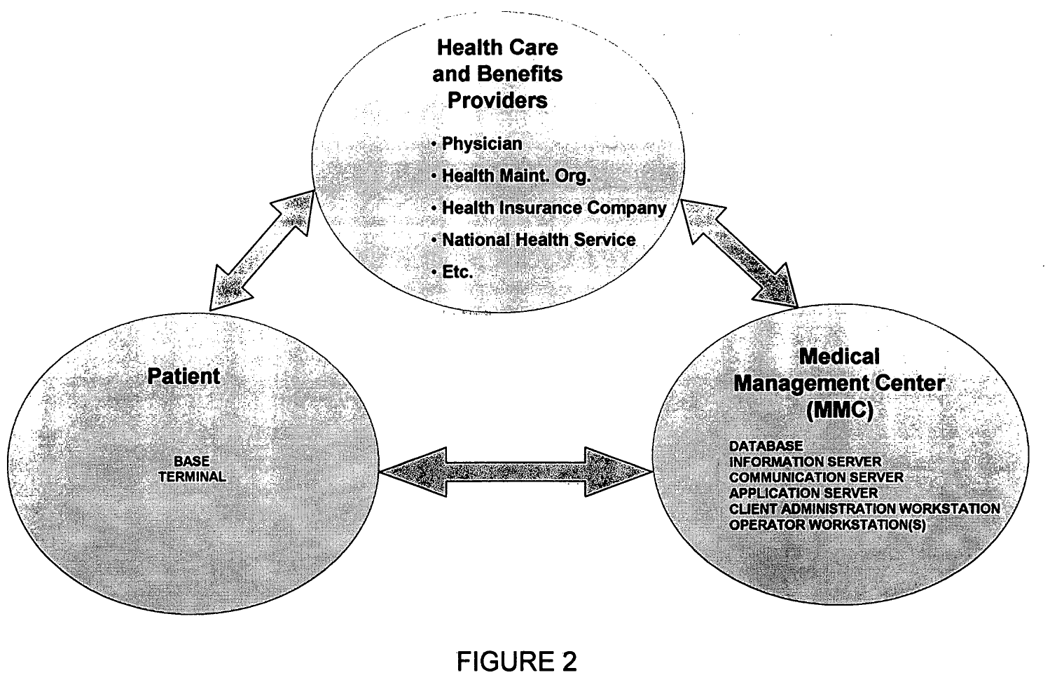

Referring now to FIG. 2, the delivery service for a health management system employs a portable base terminal and a medical management center (MMC) in communication with the portable base terminal. The base terminal and the MMC are in communication with each other and with the customer's existing health care and benefits providers (private physician, national health service, health maintenance organization, health insurance company, etc.), preferably over a communications network such as the Internet.

The MMC has a number of staff members, who have diverse, specialized daily activities. The staff members include administrative personnel, medical personnel, and technical personnel.

The administrative personnel receive customer calls, carry out administrative tasks, and redirect customer calls that require medical support.

The medical personnel evaluate the medical information received, provide medical advice to customers, as well as advice to customers on other topics related to the their health, and manage the medical services required by the client depending on his health condition.

The technical personnel provide remote maintenance of the customers' base terminals as well as maintenance of the various components of the MMC.

The MMC performs a number of functions. It identifies every user; maintains a medical database of personal medical data for each customer, including the customer's personal medical history, receives test data from customers and analyzes the test data; and protects the confidentiality of the customer data.

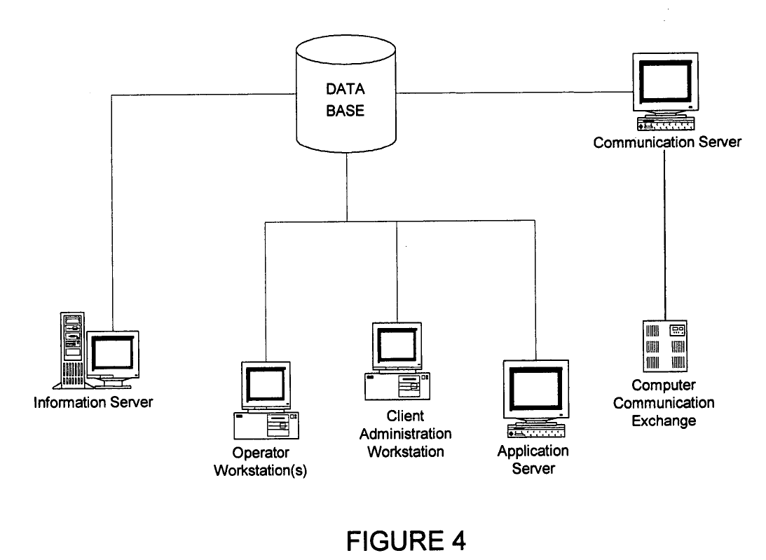

As shown in FIG. 4, the MMC comprises six components that provide support to all of its functions. The components of the MMC are a database, a client administration workstation, an application server, a number of client workstations (only one client workstation is shown in FIG. 4), a communication server, and an information server. The interaction between these components follows a client-server model, so each component has the characteristics of a client or a server depending on the assigned function. The number of client workstations corresponds to the number of clients in the client-server network.

The database provides storage of information associated with all the activities of the system. All the information managed in the MMC is centralized in the database.

The client administration workstation is a computer workstation specifically designed for network management. It provides support to the activities of the staff members of the MMC.

The application server executes applications, which carry out control and scheduled tasks through programs that are executed autonomously, without the supervision or intervention of MMC staff members. Two of these programs are a test evaluation program and a test distribution program. The test evaluation program evaluates tests when they arrive at the MMC, assigning a value (Normal, Pathological, Urgent Pathological) to each parameter in particular, and to the test in general, based on a series of pre-established values. The test distribution program distributes the test evaluations among the appropriate medical personnel depending on the value assigned to the tests by the test evaluation program.

An operator workstation is provided for each staff member of the MMC. Each operator workstation is customized with the necessary programs to carry out the particular functions of that operator workstation. The user profile of the staff member working at a work station determines which functions of the work station the staff member will be able to access. That is, each staff member's user profile identifies whether he or she is administrative, medical, or technical staff, and enables the staff member to access the corresponding administrative, medical, or technical functions at whichever work station the staff member is working.

The communication server establishes communications between the MMC's network and (1) customers, (2) customers' base terminals, and (3) customers' health care providers. This is accomplished using a computer communication exchange, as shown in FIG. 4.

The information server and its associated software provide customers of the delivery service with remote access to the information stored in the database (their test information, their medical history, and other health data) over the Internet. Thus, customers have available at all times information concerning the MMC or their own health status. The main types of information that can be accessed by the customer are test information and information on their medical history or other health data. The information server controls access to customer data through conventional security arrangements such as a customer ID and password. The data to which a customer has access is indicated by a profile associated with the customer's data.

The main functions of the base terminal are to analyze the customers' blood and other biological fluids (that is, to detect the present and amount of certain biological parameters); to obtain other health parameters such as age, weight, blood pressure, etc. directly from the customer (for example, by input through a touch screen) to send the data obtained to the Medical Management Center (MMC) via telephone, wireless, Internet connection, or any other means of telecommunication; and to receive, display, and optionally print to the customer the information provided by the MMC from the evaluation conducted by the medical personnel and, if applicable, advice concerning the maintenance of the customer's health status. At this time, it is possible to measure more than twenty parameters of biological fluids, including, but not limited to oncological markers, heart muscle stress markers, coagulation level markers, and general metabolic markers, and more specifically including, but not limited to: total cholesterol, LDL cholesterol, HDL cholesterol, glucose, creatinine, troponin T and I, myoglobin, CK-MB, prothrombine time etc. Preferably the analysis performed by the base terminal uses in vitro diagnostics performed by dry chemistry, but can also use other techniques that provide fast results and ease of use in a non-professional environment, such as reflectance photometry and immune chromatography. New tests can be incorporated into the delivery service through the base terminal, through the addition of new or the modification of the existing hardware and programming (by software, firmware, or the equivalent) of the base terminal. It is thus contemplated that the base terminal can measure any substance detectable in biological fluids. The portable base terminal communicates with the MMC to send the analysis data.

The base terminal is provided with conventional language software and applications programs, as well as a user-friendly interface and a processing unit controlled by an operating system (e.g. Linux), which supports the applications that manage all the terminal operations. Preferably, the base terminal also is equipped with a customer identification system (e.g., card reader, chip or magnetic strip). The purpose of the identification system is twofold: it protects a customer's privacy; and also allows the MMC to incorporate the analysis results into the customer's personalized medical data base to perform the interpretation of the results.

The base terminal's user interface handles interactions with the customer through a display device (e.g., a conventional liquid crystal display), an input device (e.g., a conventional keyboard controlled by the terminal applications, touch panel, etc.), and an output device (e.g., a conventional printer), which are integrated into the base terminal.

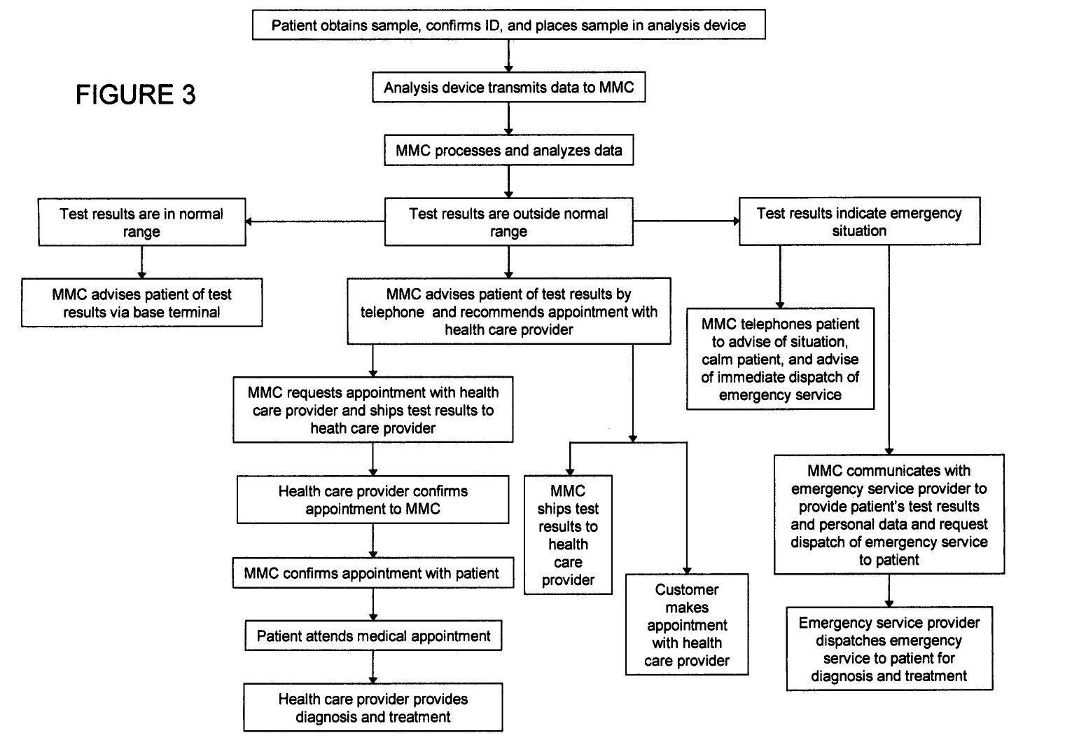

As shown in FIG. 3, in the privacy of his or her home (or other location of choice), a customer being monitored by the health management system delivery service collects samples of his or her biological fluids, which contain biological markers that can be used for the early detection of disease. The samples are obtained by a minimally-invasive or non-invasive technique. The customer then places the samples in the base terminal, which performs a medical analysis of the samples. The operations of the base terminal are controlled by the base terminal applications.

When the customer contracts for the MMC's services, the customer fills out a form with his or her relevant medical history. Subsequently, the MMC medical personnel may contact the customer to complete the medical history. Once the information from the medical history is entered into the MMC's database, the customer's medical history will be updated with the data obtained from tests conducted and transmitted by the base terminal, and with any other new data communicated to the MMC by the customer or the customer's referring physician.

Referring again to FIG. 3, once the base terminal has analyzed the test data, the base terminal transmits the analysis to the MMC, e.g. via telephone, wireless, Internet connection, etc. With the analysis of the test data, the base terminal can also transmit other health data for the customer, including but not limited to blood pressure, ECG, heart rate, oximetry, weight, age, and other data from the customer's medical history. As described above, the MMC maintains a personal medical data file for each customer of the delivery service, in order to process and analyze the information communicated to it by the portable base terminal, in order to help the customer maintain the status of his or her health throughout his or her life.

The action taken by the MMC is determined on a case-by-case basis, depending on whether the analysis returns a normal, abnormal or emergency value, and with the goal of saving the customer time and motion. When the MMC receives the analysis, medical staff at the medical management center can evaluate the analysis by comparing the analysis with the existing medical data of the customer. The analysis results are always available for the customer. If the results are normal, they are communicated by the MMC back to the customer through the base terminal, along with advise for maintaining the customer's good health. If the MMC receives data indicating possible pathological results, the staff will try to rule out causes other than disease, such as drugs the customer may be taking, foods the customer may have eaten, etc. If the staff cannot rule out other causes for the abnormal result, the staff will directly (personally) contact the customer, rather than communicating the results via the base terminal.

When the analysis results are abnormal and suggest a pathological condition, an MMC staff member will telephone the customer and advise him or her to contact his or her existing health care and benefits providers for an appointment with his or her physician, in order to reduce the medical response time as much as possible and allow for early treatment of the disease. Alternatively, if the customer gives his or consent, and so wishes, the MMC will contact the customer's existing health care and benefits providers to make the appointment on behalf of the customer. In either case, the MMC will also ship the test results to the health care and benefits providers.

If the test analysis returns an emergency value, and the medical staff's evaluation of the customer's history and other factors so indicate, the medical staff will immediately communicate with an emergency service provider to provide the customer's test results and personal data (medical history and previous test results), and request the dispatch of emergency service to the customer; and concurrently will personally contact the customer to advise him or her of the emergency, calm the customer, and advise him or her of the dispatch of the emergency service.

Modifications and variations of the above-described embodiments of the present invention are possible, as appreciated by those skilled in the art in light of the above teachings. For example, implementation of new analysis test, other diagnostic method, the use of non invasive techniques, new ways of communications, and other software tools, etc. It is therefore to be understood that, within the scope of the appended claims and their equivalents, the invention may be practiced otherwise than as specifically described.

1. A method for early detection of disease, comprising the steps of:
taking a sample of a body fluid from a patient;
analyzing the sample to detect and measure the amount of at least one substance therein and generating data representing the analysis of the sample;
transmitting the data to a medical management center remote from the user via a communications network;
at the medical management center, evaluating the data based on the medical history of the customer; and
taking action on a case-by-case basis, depending on whether the evaluation finds a normal, abnormal, or emergency value of the data.

2. The method of claim 1, wherein in the step of analyzing, the at least one substance includes at least one medical diagnostic marker.

3. The method of claim 1, wherein the step of transmitting also includes transmitting other health data.

4. The method of claim 3, wherein in the step of transmitting, the other health data includes at least one of blood pressure, ECG, heart rate, oximetry, weight, and age.

5. The method of claim 1, wherein in the step of taking action, if the evaluation finds the data are normal, the MMC communicates the results back to the customer.

6. The method of claim 5, wherein in the step of taking action, the MMC also communicates to the customer advise for maintaining the customer's good health.

7. The method of claim 1, wherein in the step of taking action, wherein the step of evaluating includes with respect to data indicating possible pathological results, attempting to rule out causes other than disease

8. The method of claim 7, wherein if in the step of evaluating, the MMC cannot rule out other causes for the possible pathological result, then in the step of taking action, the MMC personally contacts the customer and advises the customer to seek medical attention.

9. The method of claim 7, wherein if in the step of evaluating, the MMC cannot rule out other causes for the possible pathological result, and the result indicates a possible emergency condition, then in the step of taking action, the MMC immediately communicates with an emergency service provider to provide the customer's test results and personal data, and requests the dispatch of emergency service to the customer; and concurrently personally contacts the customer to advise the customer of the emergency, calm the customer, and advise the customer of the dispatch of the emergency service.

10. The system of claim 2, wherein in the analyzing step, the at least one marker includes at least one of oncological markers, heart muscle stress markers, coagulation level markers, and general metabolic markers.
